(19) United States
(12) Patent Application Publication
(10) Pub. No.: US 2012/0159777 A1
(43) Pub. Date: Jun. 28, 2012

(54) SOCKET SWITCH

(75) Inventor: Nicholas Fletcher, Brighton (AU)

(73) Assignee: LanthioPep B.V., Groningen (NL)

(21) Appl. No.: 13/318,982

(22) PCT Filed: May 4, 2010
(86) PCT No.: PCT/AU2010/000513

§ 371 Date: Mar. 15, 2012

(30) Foreign Application Priority Data
May 4, 2009 (AU) 2009901944

(51) Int. Cl. H01R 13/44; H01R 43/26

(52) U.S. Cl. 29/825; 439/131

(57) ABSTRACT

An electric power socket (15a) for receiving an electric plug (80) having a plurality of axially parallel plug pins (86), the power socket including: (a) a rear portion (60) housing a set of electrical connections 88 for making electrical contact with the corresponding plug pins (86); (b) a fixed portion 40 including α set of guides (42) for reception of the corresponding plug pins; (c) an axially fixed rotatable body 20 retained in a circular cavity (16), biased to an electrically inactive position and rotatable R through an extent of travel to an active position, the rotatable body including a front wall (30) through which extends a corresponding set of apertures (24) to receive the plug pins; and (d) a detent (46, 50) for cooperating with at least a first one of the plug pins in the active position and to resist rotation of the rotatable body toward the inactive position, wherein: (i) each aperture remains in registration with a corresponding one of the guides (42) through the extent of travel; and (ii) the rotatable body returns under bias to the inactive position if the plug pins are withdrawn from the power socket.

### FIELD OF INVENTION

This invention relates to a socket for an electric power socket.

### BACKGROUND ART

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

Electric power sockets are generally mounted to structures at accessible heights and positions. Such power sockets generally have a switch adapted to activate the power socket to allow power to connect to a complimentary electric plug insertable therein. This can create a potential hazard where a power socket is rendered live by activating the switch with no electric plug covering the socket terminals. Not only may a small child dangerously insert a conductible element into a live socket, but splashed or rising water, for example in a localised flood situation, may create an electrocution hazard by allowing the possibility for live terminals to be exposed.

One prior art attempt is described in Australian Patent No. 693108 by Cullen that shows an electric power outlet socket that is activated by inserting an electric plug into the outlet socket, depressing a rotatable body whereby to permit rotation of the plug and rotating body to an active position. However, because this prior art attempt requires that the plug receptacle 8 be axially slidable to allow rotation about its axis, it can prove more difficult for persons lacking dexterity, for example the aged or infirm, to manipulate the electric plug to the active position. Moreover, it would be advantageous to have an arrangement with less working and moving parts to minimise both manufacturing costs and production times as well as increase the durability of the arrangement for the purposes of warrantees and industry standards.

An object of the present invention is to ameliorate the aforementioned disadvantages of the prior art or to at least provide a useful alternative thereto.

### STATEMENT OF INVENTION

Accordingly, in one aspect of the invention there is provided:
an electric power socket for receiving an electric plug having a plurality of axially parallel pins, the power socket including:
   a rear portion housing a set of electrical connections for making electrical contact with the corresponding plug pins;
   a fixed portion including a set of guides for reception of the corresponding plug pins;
   an axially fixed rotatable body retained in a circular cavity, biased to an electrically inactive position and rotatable through an extent of travel from the inactive position to an active position, the rotatable body including a front panel through which extends a corresponding set of apertures to receive the plug pins; and
   a detent for cooperating with at least a first one of the plug pins in the active position and to resist rotation of the rotatable body toward the inactive position,
      wherein:
each the aperture remains in registration with a corresponding one of the guides through the extent of travel; and
the rotatable body returns under bias to the inactive position if the plug pins are withdrawn from the power socket.

The electric plug may be made according to any one of a number of jurisdictional standards, such as the Australian standards. However, the present invention relates to numerous other standards relating to electric plug and complementary socket types including earthed and unearthed electrical devices having, respectively, three and two plug pins.

There are two basic standards for voltage and frequency throughout the world. One is the North American standard of 110-120 volts at a frequency of 60 Hz. The other is the European standard of 220-240 volts at 50 Hz. In summary, there are presently about 14 types of AC power plugs and sockets in use (typically labelled Types A M and listed in the table below). For example, the National Electrical Manufacturers Association (NEMA) has a Type B plug (NEMA 5-15, 15 A/125V grounded) that has two flat parallel blades and a round or U-shaped earthing prong.

A Type C plug (CEE7/16-Euro plug 2.5 A/250V unearthed) is used in Europe, Eastern Europe, Middle East, South America and the subcontinent. In Australia, a type T plug made according to Australian standard 3112 (Australian 10 A/240V) is used having an earthing pin and two flat current-carrying pins forming an upside down V shape. Although the invention will primarily be described with reference to this standard Australian plug and corresponding socket, the invention has application with the various other AC power sockets and plug sets available throughout the world.

Preferably, the electric plug casing operates as a handle or knob which may be manipulated in the manner of a switch to rotate the rotatable body by the electric plug to connect the plug pins to electric power. The electric plug casing is preferably made from moulded insulating material, such as a plastic, including polypropylene, ABS, etc. The electric plug casing preferably has surface features to enable the plug to be easily gripped and rotated. For example, the surface features may include grooves, ridges, dimples or knobs adapted to allow a user's fingers to grip the casing surface. The surface features may include depressions corresponding to the fingers of a user applying a grip position to the electric plug casing.

Preferably, the fixed portion is a housing shaped as a cylindrical disc. The fixed portion may be a moulded structure. The fixed portion may be moulded separate from the socket switch housing. Alternatively, the fixed portion may be integrally formed with the socket switch housing. However, preferably the fixed portion is moulded separately and is insertable in a pre-formed cavity in the socket switch housing. The pre-formed cavity may correspond to the circular cavity, that is the respective cavities may be aligned and may form a single, for example, cylindrical cavity, or may be stepped so that the pre-formed cavity has a different diameter to the circular cavity. In front elevation, the fixed portion may be square, oval, polyonal or another shape. When slotted into a correspondingly shaped cavity, the fixed portion may resist rotation relative to the socket switch housing. The fixed portion is preferably radially symmetrical and axially aligned with the rotatable body. The fixed portion is preferably radially symmetrical and axially aligned with the rotatable body. The pre-formed cavity for the fixed portion is preferably circular. The fixed portion may have snap fit engagement members that are adapted to co-operate with corresponding elements in the fixed portion receiving cavity of the socket switch housing to enable optionally releasable engagement. The snap fit means may be releasable to enable substitution by a replacement part or may be non-releasable for insertion during manufacture or later assembly prior to use.

The guides may be defined by cavities moulded into the fixed portion. The guides may include crimps. Preferably, the guides are crimps and the fixed portion is a crimp housing. The guides may include internal walls along which the respective plug pins may follow through the extent of travel. Preferably, as the plug pins are rotated through the extent of travel, the guides apply lateral force to bear at least one of the plug pins into a frictionally locked position in the active position. The guides may include a recess at the end of the extent of travel corresponding to the active position. The recess may be a recessed portion. The recess may be preceded by a ramp. The ramp may marginally bend one or more of the plug pins laterally of their respective axes. The bent plug pins may come to rest in the recess in a less bent position. The may effectively retain the plug against reverse rotation so that the plug is effectively locked in place against rotation. The effective locking of the plug pins in the end portions of the guides acts to prevent accidental displacement of the plug pins from the guide end portions. Preferably, the guides are in the form of contoured slots along which the respective plug pins move through the extent of travel. Preferably, the guides are in the form of contoured slots along which the respective the plug pins move through the extent of travel.

The socket switch housing may come in a variety of forms such as the wall mounted socket casing, multiple socket housings, such as in the skirting board of shop or office fittings, or in the form of extension blocks or multiple adaptors that are adapted to co-operate with existing socket installations. Depending on the application, the socket may supply mains AC power in the Australian context of the type 1 plug referred to above, in the form of a 10 amp or 15 Amp socket and plug arrangement. The 10 amp arrangement may exclude the earth pin for low power appliances such as shavers and radios. Preferably, in one aspect the plurality of plug pins includes an active pin and a neutral pin. For higher power appliances, such as electric drills, fridges, hair dryers and the like, an earth pin will be required.

Preferably, in another aspect the plurality of plug pins includes an active pin, a neutral pin and an earth pin.

Depending on the type of socket and plug arrangement, the plug pins may be a range of shapes, such as solid cylindrical, blade, trapezoid, triangular or otherwise polygonal. The plug pins may be differently shaped to each other.

At least one of the plug pins may be in the shape of a blade having a plane aligned substantially radially relative to the rotatable body's axis.

The detent may include a movable member that is urged into position as the plug casing is rotated. The detent may be mounted on a flexible arm or shaft that is drawn or pushed into position by the rotation of at least one pin. Preferably, the detent is secured to the fixed portion and comprises a resiliently deflectable arm. The detent may move into position immediately behind the first plug pin on completion of rotation of the plug to the active position. The detent may include a friction-locking member. The detent may abut against the first plug pin and a side wall of the corresponding guide to releasably lock the plug pin into the corresponding guide. Preferably, in the active position, the detent bears against the first plug pin whereby to frictionally trap the first plug pin against a wall of the corresponding guide. The detent may be mounted on a flexible arm. The flexible arm may be engaged by the first plug pin on insertion of the plug into the socket. The plug may be inserted into the socket in the initial inactive position. The detent may include the aforementioned ramp means integrally formed in a guide wall whereby to provide resistance to the reverse rotation of the plug away from the active position. The detent may resist reverse rotation of the plug in normal use back to the inactive position. The rotatable body may only return to the inactive position upon withdrawal of the first plug pin or the plug pins from the socket.

The rotatable body may be of substantially constant cross section along its rotational axis.

Preferably, the rotatable body is a casing shaped as a cylindrical disc. The cross section of the rotatable body may be circular at any point along its length, but may vary in diameter at different points. For example, the rotatable body may have an annular flange adapted to axially retain the rotatable body in a corresponding annular groove of the socket housing. The rotatable body may be frusto-conically shaped so that it is axially trapped in the socket switch housing where the narrowest portion of the frusto-cone is facing outwardly. Alternatively the wide end of the frusto-cone may face outwardly and the rotatable body may be retained in a correspondingly frusto-conical cavity by, for example, a socket switch casing cover plate with an aperture through which the socket apertures for receiving the plug pins exposed.

Preferably, the rotatable body is aligned coaxially with the fixed portion. [D12a] The size and, more particular by, the width of the fixed portion may be different to that of the rotatable body. For example, the fixed portion may be wider or have a greater diameter than the rotatable body or vice versa. The fixed portion may have an axially extended annular wall within the rotatable body rotatably rests.

Preferably, the rotatable body and the fixed portion have substantially the same diameter. The socket cavity into which the fixed portion and the rotatable body may be inserted and retained in use may be substantially cylindrical and of a constant cross section.

The bias may be any suitable resiliently deformable means or member capable of returning the rotatable body to the inactive position on release of the detent. Accordingly, preferably the bias is able to apply sufficient rotational force to rotate the rotatable body through the extent of travel back to the inactive position, but insufficient to overcome the rotation resisting force of the detent in the active position. The bias may include a variety of different spring types or arrangements. The bias may be a torsional spring, a plurality of radially spaced leaf springs, an elastic material such as rubber, natural or synthetic, or any other type of suitable spring. The bias may be a spiral spring. The spiral spring may be arranged to be spirally wound around a longitudinal axis. The bias may lie in a plane normal to the longitudinal axis.

Preferably, the bias is in the form of a spiral spring. The bias may lie in a transverse plane normal to the longitudinal or rotational axes. The transverse plane may be substantially coplanar with or lie in an adjacent parallel plane to the facing internal surfaces of the rotatable body and the fixed portion. The spring may be centrally mounted on the rotatable body or the fixed portion. Advantageously, the bias lies in the transverse plane to enhance the compact size of the inventive arrangement. A centrally located and sprung bias is adapted to provide a radially balanced rotational body whereby to minimise wear through rotation and to extend the life of the replacement parts such as the rotatable body.

The bias may include a spring catch adapted to hold the spring in the active position and to resist reverse rotation back to the inactive position from the active position. Preferably, the spring is mounted on the rotatable body and the fixed portion includes a spring catch against which the spring bears. Preferably, the spring catch is released from the spring or other bias means when the plug pins are withdrawn from the socket to permit the rotatable body to reverse rotate back to the inactive position under the force of the bias.

In another aspect, the invention provides:
a method for activating an electric power socket for receiving an electric plug having a plurality of axially parallel pins, the method including the following steps:
housing a set of electrical connections for making electrical contact with the corresponding plug pins in a rear portion of a casing of the electric power socket; including a set of guides for reception of the corresponding plug pins in a fixed portion in the casing; retaining an axially fixed rotatable body in a circular cavity in the casing; biasing the rotatable body to an electrically inactive position, the rotatable body including a front panel through which extends a corresponding set of apertures to receive the plug pins; inserting the electric plug into the rotatable body so that the plug pins extend through to the fixed portion; and rotating the electric plug and therefore the rotatable body through an extent of travel from the inactive position to an active position until at least a first one of the plug pins cooperates with a detent in the active position that resists rotation of the rotatable body toward the inactive position, wherein: each the aperture remains in registration with a corresponding one of the guides through the extent of travel; and the rotatable body returns under bias to the inactive position if the plug pins are withdrawn from the power socket.

### BRIEF DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. In the drawings:

FIG. 1 is a front view of a socket switch housing according to a first embodiment;

FIG. 2a is a rear view of the socket switch housing shown in FIG. 1;

FIG. 2b is a side view of the socket switch housing shown in FIG. 1;

FIG. 3 is a front view of the socket switch housing shown in FIG. 1;

FIG. 4a is a schematic front view of the socket switch housing shown in FIG. 1;

FIG. 4b is a side view of a plug according to a preferred embodiment of the invention;

FIG. 5 is a schematic front view of a socket switch housing according to a second embodiment of the invention;

FIG. 6 is a rear view of the socket switch housing shown in FIG. 5;

FIG. 7 is a rear sectional view of the socket switch housing shown in FIG. 5;

FIG. 8a is schematic perspective view of a rotatable body according to a second embodiment of the invention;

FIG. 8b is a schematic exploded perspective view of a rotatable body and a fixed body according to the second embodiment;

FIG. 8c is a schematic side sectional view of the fixed body and a rear terminal housing according to the second embodiment;

FIG. 8d is a rear sectional view of the second socket shown in FIGS. 5-7;

FIG. 9a is a front view of a rotatable body according to a third embodiment of the invention;

FIG. 9b is a schematic exploded perspective view of the rotatable body and a fixed body according to the embodiment shown in FIG. 9a;

FIG. 10a is a perspective view of a detent pin lock according to the third embodiment of the invention;

FIG. 10b is a top plan view of the detent pin lock shown in FIG. 10a;

FIG. 10c is a schematic perspective view of the rotatable body and the fixed body according to the third embodiment;

FIG. 10d is a schematic side sectional view of a plug engaged in the rotatable body and the fixed body in accordance with the third embodiment of the invention;

FIG. 11 is a schematic exploded perspective view of the rotatable body and a fixed body according to a fourth embodiment of the invention;

FIG. 12a is a schematic side sectional view of rotatable and fixed bodies in accordance with the fourth embodiment of the invention prior to engagement with plug pins;

FIG. 12b is a schematic side sectional view of the fourth embodiment as the plug is inserted;

FIG. 12c is a schematic side sectional view of the fourth embodiment showing the plug pin fully inserted into a crimp;

FIG. 12d is a schematic side sectional view of the fourth embodiment showing the plug rotated to the active position;

FIG. 12c is a schematic side sectional view of the fourth embodiment after the plug pins have been removed from the pin apertures;

FIG. 13 is schematic perspective view of a rotatable body according to a fifth embodiment of the invention; and

FIG. 14 is a schematic exploded perspective view of a rotatable body and a fixed body according to the fifth embodiment.

### DETAILED DESCRIPTION OF THE DRAWINGS

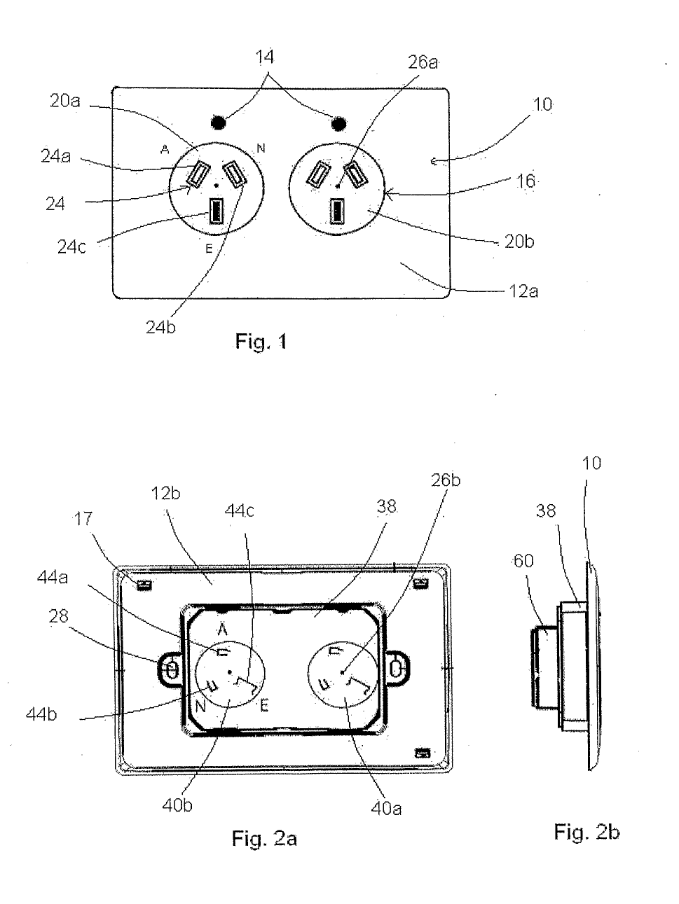

As shown in FIG. 1 the invention according to the first embodiment includes a socket switch casing 10 according to a first embodiment. The socket switch casing 10 includes a front fascia panel 12a and a pair of rotatable bodies 20a, 20b inserted in a corresponding pair of cylindrical cavities 16 formed in the socket switch casing 10. The rotatable bodies 20a, 20b include a plurality of pin apertures 24 arranged in accordance with the Australian standard for a 10 amp/240 volt electrical socket and plug connection having an active pin aperture 24a, neutral pin aperture 24b and earth aperture 24c. The skilled person will appreciate that other electrical socket arrangements made in accordance with jurisdictional standards in other countries and regions are equally applicable to the present invention, including without limitation the fourteen types of AC power plugs and sockets referred to as types A-M listed below.

The fascia panel 12a includes a pair of LED indicators 14 that indicate the live or dead status of the socket 20a, 20b immediately below it. Each of the rotatable bodies 28a, 20b are rotatable about rotational axes 26a.

Referring to FIGS. 2a and 2b, the rear of the fascia panel 12b is shown. The front fascia panel 12a and the rear panel 12b may comprise separately formed panels that may be snap fit together by snap fit fasteners 17 according to standard practice.

Mounted on to the rear panel 12b by mounting means 28 is a fixed housing 38 that includes a continuation of the cylindrical cavity 16 through the body of the fixed housing 38. The pair of cylindrical cavities 16 are shared by the pair of rotatable bodies 20a, 20b and a corresponding pair of fixed bodies 40a, 40b respectively coaxially aligned to rotatable bodies 20a, 20b. Housed within each of the fixed bodies 40a, 40b are a set of plug pin receiving crimps, including end crimp portions 44, namely active end crimp portion 44a, neutral end crimp portion 44b and earth end crimp portion 44c, respectively. The fixed bodies 40a, 40b are coaxially aligned with the rotatable bodies 20a, 20b along respective longitudinal axes 26b of each member of pair of cylindrical cavities 16.

The socket switch casing 10 further includes a rear terminal housing 60 in accordance with standard practice. The rear terminal housing 60 may be electrically connected to mains AC wiring, namely active (A), neutral (N) and earth (E) connections in accordance with standard practice.

The fixed bodies 40a, 40b are received in the corresponding pair of cylindrical cavity 16 whereby they are fixed against rotation about the rotational axes 26a. This may be achieved by a number of arrangements whereby the fixed bodies 40a, 40b are secured to the socket casing 10, and more particularly to the internal walls of the cavity 16, including without limitation heat fusion or welding, adhesive or a combination of one or more longitudinally aligned ridges or protrusions and grooves in the outer surface of the fixed portions 40a, 40b and the internal surface of the cavity 16.

The rotatable disc housing 20a, 20b may be trapped within the cylindrical cavity 16 to prevent axial movement, but to allow rotational movement about the rotational axis 26a. For example, the rotatable housing 20a may be trapped behind fascia panel 12a which may have an aperture in registration with the cavity 16 but having a smaller diameter so that the rotatable housing cannot move axially relative to the fixed body 40a, 40b or the fascia panel 12a.

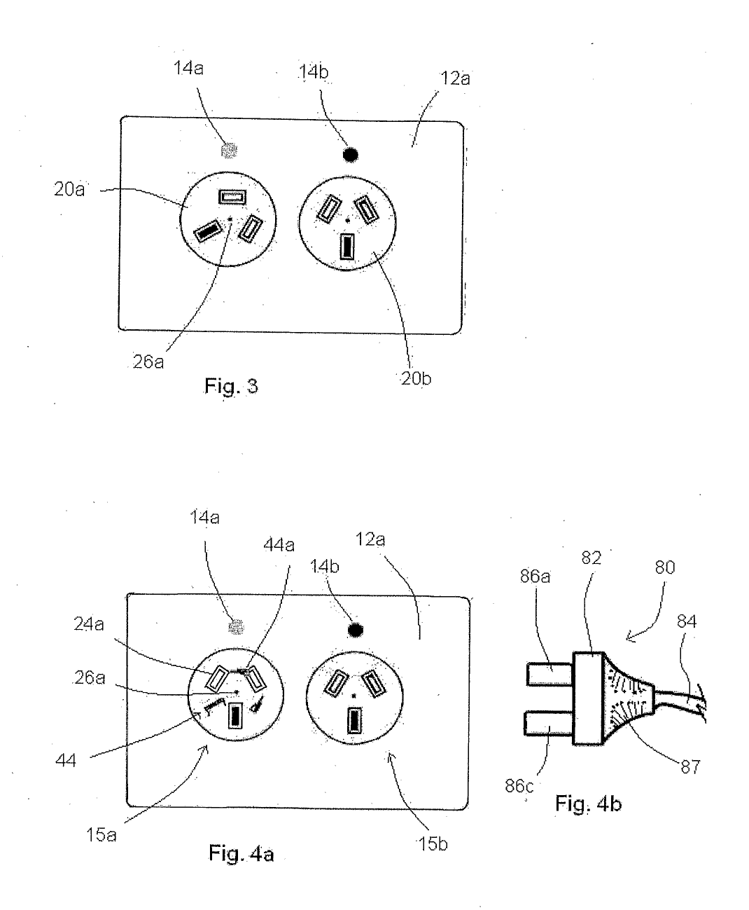

As shown in FIG. 3, rotatable housing 20a may be rotated clockwise to turn the socket from an inactive position (for example, as shown with respect to rotatable housing 20b in FIG. 3) to the active position assumed by rotatable housing 20a in FIG. 3. The rear terminal housing 60 indicates the active state of the socket corresponding to rotatable housing 20a by activating LED indicator 14a. With reference to FIGS. 4a and 4b, rotation of the rotatable housing 20a is advantageously achieved by insertion of the plug 80 into the socket 15a to enable rotation of the rotatable housing 20a. The rotatable housing 20a may include stops (not shown) that prevent rotation of the rotatable housing 20a without the aid of a plug 80.

The plug 80 may include a plug casing 82, plug pins 86a-86c, plug cord 87 and finger grip features 87. The finger grip features 87 may include circumferentially spaced indentations corresponding to the thumb forefinger and middle finger and/or may include friction grip features, such as grooves, ridges and the like. Preferably, the plug casing 82 is made from a material having good frictional properties and electrical insulation for minimising electrical shock risk.

In FIG. 4a there is shown a socket 15a. In use, the pins 86 are inserted into the corresponding pin apertures 24 (shown as ghosted lines to indicate the inactive position), the plug case 82 is rotated clockwise about 60 degrees so that the pins move through an extent of rotational travel until they each releasably engage with the corresponding end crimp portions 44. The end crimp portions 44 are sufficiently resiliently deformable to frictionally secure the pins 86 in the corresponding end crimp portions 44, so that the plug 80 will not counter-rotate anticlockwise unless sufficient anticlockwise rotational force is applied to the plug 80 to return the plug 80 to the inactive position (corresponding to a position shown in respect of socket 15b in FIG. 4a).

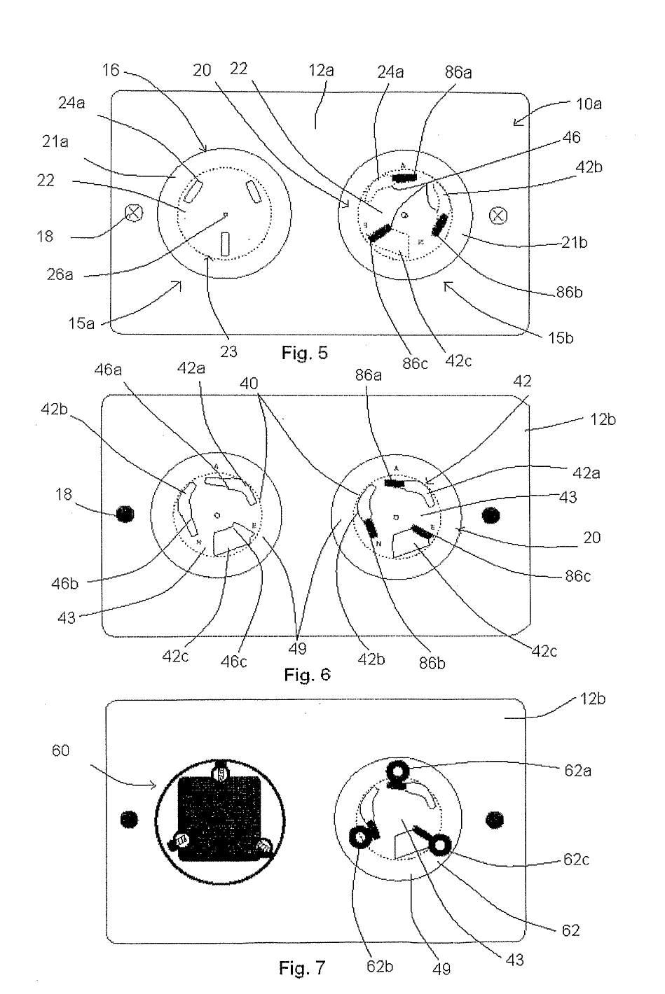

In FIG. 5 there is shown the front panel 12a of a socket switch casing 10a according to a second embodiment of the present invention. The socket switch housing 10a comprises a pair of sockets 15, comprising first and second sockets. The sockets 15 have 15a, 15b a corresponding pair of rotatable disc housings 20 comprising an outer hollow cylindrical disc 21a, 21b adapted to rotatably fit in the cylindrical cavity 16 and defining an inner cylindrical cavity 23 into which is inserted an insert aperture body 22. The insert 22 is an aperture body including an array of apertures for receiving plug pins according to any one of a range of pin configurations. The insert aperture body 22 may be varied from jurisdiction to jurisdiction or from one socket type to another to accommodate different socket types. The socket casing 10a may be provided with a variety of possible insert aperture bodies 22 to adapt the socket casing 10a to anyone of a variety of socket plug arrangements, including types A-M listed below.

Turning now to the second embodiment shown in FIGS. 5-8d, with reference to the second socket 15b, pin guides 42 in the form of active, neutral and earth crimps 42a-42c are shown in ghosted lines. The pin guides or crimps 42 are housed in a fixed body 40 behind the rotatable body 20 as best seen in FIGS. 6 and 7.

The fixed body 40 also includes a crimp containing insert 43 in the form of a disc inside an outer fixed donut shaped cylinder 49 corresponding to the insert aperture body 22 and outer hollow cylinder disc 21a, 21b. The crimps 42 define carefully contoured guides of specific design for each of crimps 42a-c to control the movement of the pins 86 through the extent of travel from the inactive position as exemplified in socket 15a in FIG. 5 through to the active position exemplified by socket 15b in FIGS. 5 and 6.

With reference to FIG. 6, rotation of the pins 86 and the rotatable body 20 represents an anticlockwise rotation to move the active pin 86a to a top most position (A) by the rotating action. The guiding crimps 42 apply marginal lateral force to the pins 86 as they are guided through the cavities defined by the crimps 42 until the pins 86 meet a respective ramp 46. Different crimp guide shapes or configuration will be required to accommodate the different plug and pin arrangements according to different design standard applicable in different jurisdictions. Although the Australian 3-pin 10 Amp standard is shown as an example in the drawings, it will he appreciated that other socket types of the standards A-M are considered to be equally applicable to the present invention. In each socket and pin arrangement, the crimps are shaped to apply inwardly or outwardly radial force or lateral force to one or more pins as they rotate about a plug axis. This may urge the pins into a flexed position whereby they are held in the active position by frictional forces. Alternatively or in addition, in the case of ramped walls forming part of the inner walls of one or more of the crimps, a crimp shoulder forming part of the crimp wall may bear against the pin as it rotates until it rides over a wall ramp into a less flexed active position. In another alternative, the crimp walls themselves may be resiliently flexible to provide the flex within the fixed body 40 to accommodate substantially or relatively rigid and/or inflexible pins.

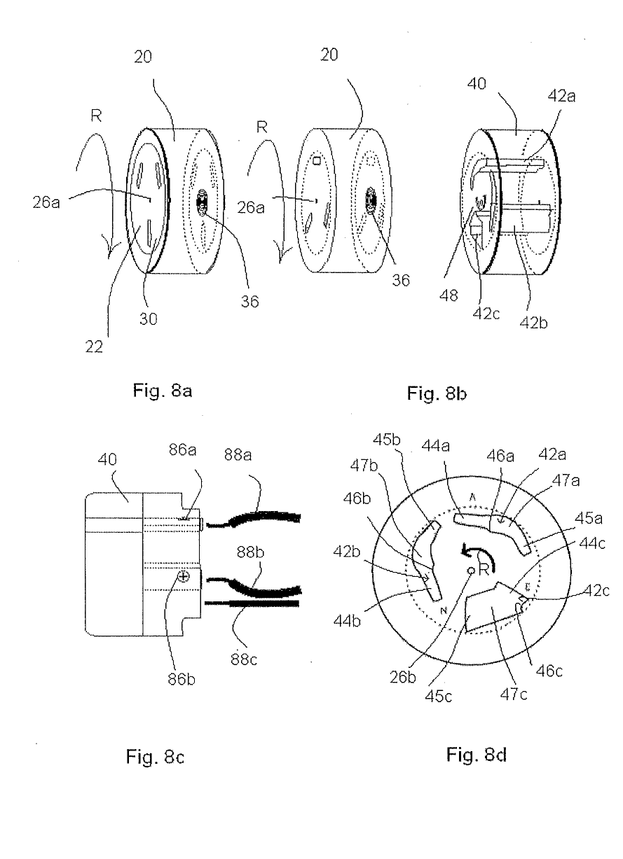

As best shown in FIG. 8d guide crimps 44a-44c have respective ramps 46a-46c in the form of indented wall formations that cause radial displacement of the pins 86 as they are rotated into the active position. The guide crimps 44a-44c generally include three separate zones: a pin entry zone 44a-c, a transition zone 47a-c in which the pins 86 travel from the active position at the pin entry zones 45a-c on their way to the end crimp portions 44. The arrow R indicates the direction of rotation of the pins 86 from the inactive to the active position. The active and neutral apertures 24a, 24b are similar in shape and rotated about 60 degrees relative one to the other. The active and neutral apertures 24a, 24b include ramp portions 46a, 46b. The leading edge of the pin 86a, 86b must ride over the ramps 46a, 46b against the bias of the respective pins to their respective longitudinal axes to enter the respective end crimp portions 44a, 44b.

The active and neutral pins 86a, 86b are therefore held in place in the end crimp portions 44a, 44b in a slightly flexed position. This is against the tendency to an orientation aligned with the longitudinal axes of the active and neutral pins 86a, 86b in their resting position. Accordingly, the pins 86 are held in place in the end crimp portions 44 primarily by friction forces in this second embodiment. Because the earth pin 86c has a blade shape that is aligned radially relative to the longitudinal axis 26b, the earth pin 86c moves through the extent of travel in a rotational direction substantially normal to the plane of the blade of the earth pin 86c. The accommodating guide crimp 24c is therefore correspondingly broad in shape. Immediately before the earth end crimp portion 44c is a ramp portion 46c that a leading edge of the earth pin 86c must ride over to enter the earth end crimp portion 44c.

Other crimp shapes will be advantageously employed for different shaped and oriented plug pins. However, in each case, the crimps 42 will include a corresponding ramp 46 over which the plug pin 86 must ride to enter the end crimp portion 45.

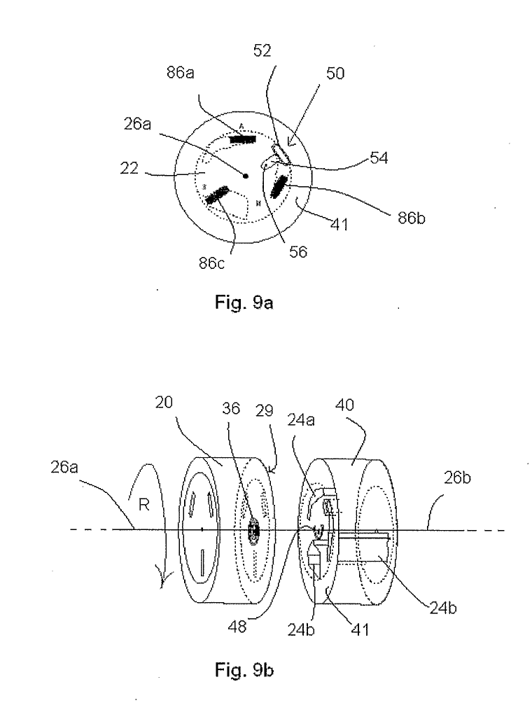

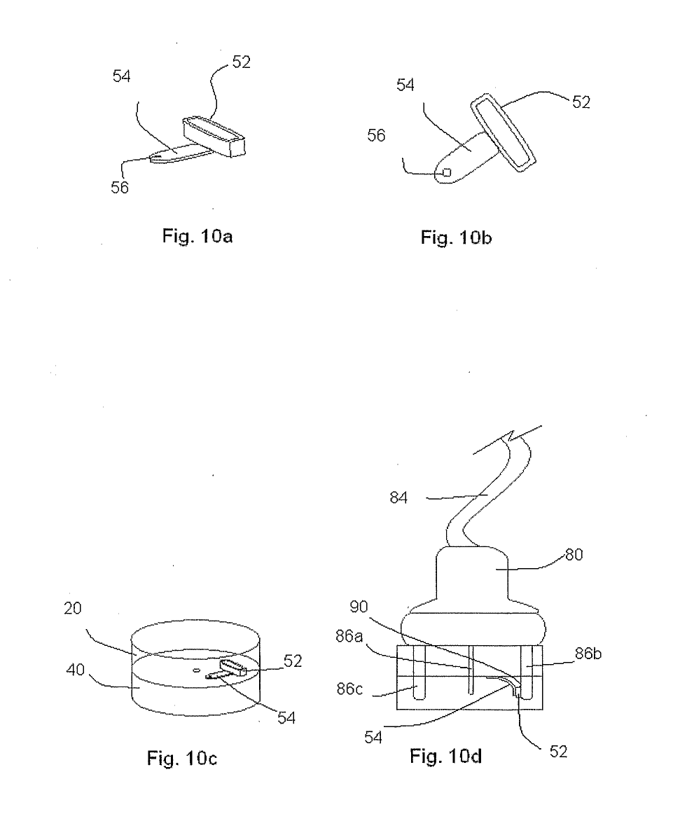

Referring to FIGS. 9a-10d, there is shown a third embodiment of the invention that is similar to the second embodiment, but comprises an optional detent pin lock 50 in a preferred form of the invention that includes a lock head 52, a resiliently deformable arm 54 and a pivot anchor 56 mounted to the inner surface 41 of the fixed housing 40 or insert 43. The lock head 52 is adapted to engage with the leading tip and side wall 90 of the neutral pin 86b and be dragged down into the neutral crimp 42b cavity as the neutral pin 86b enters the neutral crimp 42b. This is most clearly seen in FIG. 10d. The neutral pin 86b may be rotated clockwise with the lock head 52 resting against the abutting wall 90 of the neutral pin 86b. The lock head 52 follows with the deflectable arm 54 rotating about the pivot anchor 56 until the neutral pin 86b comes to abut against the neutral end crimp portion ramp 46b. The neutral pin 86b then rides over the ramp and is friclionally gripped in the active position in the neutral end crimp portion 44b. The resiliency deformable arm 54 flicks the detent pin lock 50 into a position behind the neutral pin 86b. The presence of the pin lock 50 behind the pin 86b prevents the neutral pin 86b returning in an anticlockwise rotational direction under the influence of the bias 36 as will be described below. Accordingly, the detent pin lock 50 is effective to hold the plug in place in the active position and to prevent it counter rotating hack to the inactive position once inserted into the socket 15a, 15b and rotated to the active position.

As best seen in FIG. 9b in a preferred embodiment, the bias is in the form of a spiral return spring 36 that lies in a plane between the facing internal faces 29, 41 of the rotatable housing 20 or insert 22 and the fixed housing 40 or insert 43. The spiral spring 36 is centrally anchored at a point close to or corresponding to the longitudinal axis 26b. The outer end of the spiral spring 36 is anchored to a spring catch 48 on the fixed portion internal surface 41.

Accordingly, in use, the plug 80 is inserted into a socket 15. On its withdrawal from the socket 15, the pin retaining mechanism in the form of the detent 46, 50 is removed and the socket 15 may be rotated back to its inactive position under the urging of the spring bias 36.

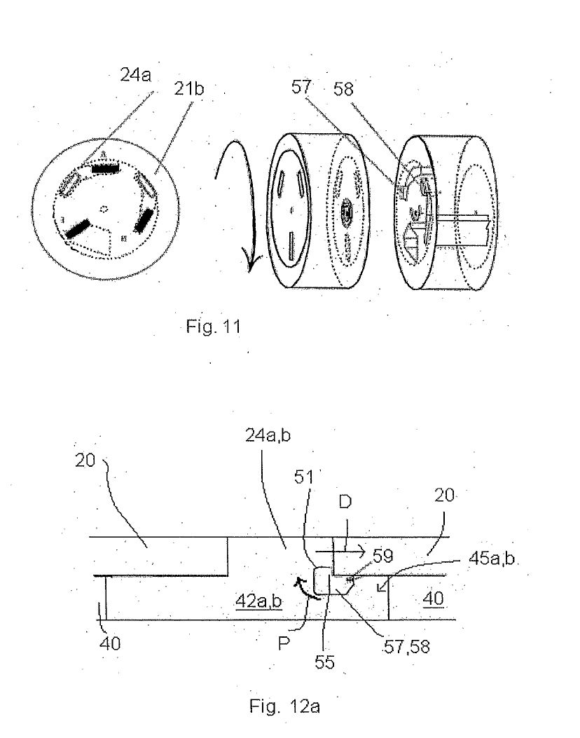

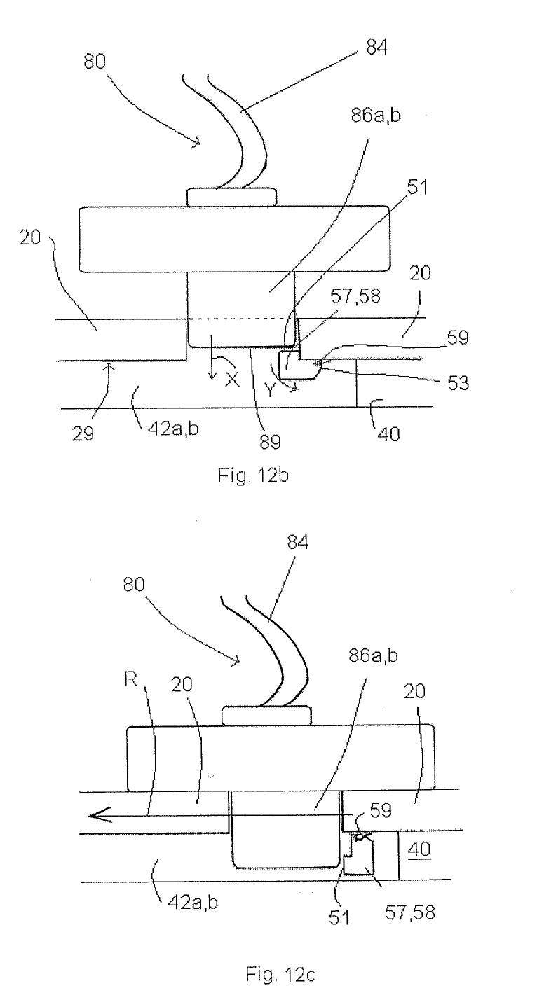

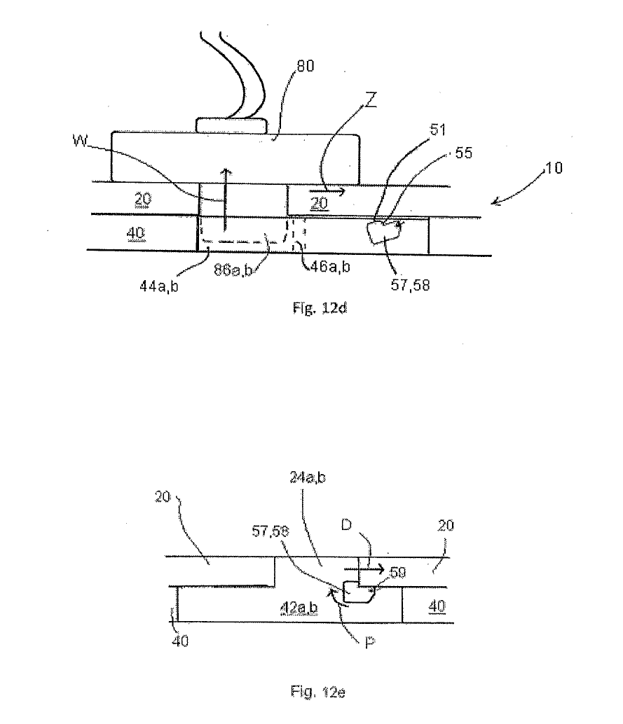

Referring to FIGS. 11 to 12e, there is shown a fourth embodiment having a pair of pivot detent locks 57,58 pivotally mounted to the respective walls of the active and neutral crimps 42a,b. Of course, the skilled person will appreciate that the arrangement may operate with only one detent 57 or detent 58 acting in relation to either the active crimp 42a or the neutral crimp 42b, respectively. The components described with reference to these drawings will be described by reference to the rotating body 20 being uppermost and lying in a horizontal plane.

The pivot detent locks 57,58 comprise a solid body or block that is pivotally spring mounted about a hinge by a spring 59. The spring may be formed of metal or plastic and may be formed integrally with the fixed body or the lock 57,58. Preferably, the spring 59 is formed from plastic and attached or integrally formed with an internal wall of the active or neutral crimp 42a,b near the pin entry zone 45a,b.

The pivot detent locks 57,58 remain in an upper and generally horizontal orientation aligned parallel to the plane of the fixed housing 40 when not engaged to a pin 86 by the locking of the elbow 55 engaging a corner wall of the pin aperture 24a,b in the rotatable disc housing 20. The bodies of pivot detent locks 57,58 each include a pin 86 abutting surface, edge or wall 51 that extends upwardly in the inactive position shown in FIG. 12a. The detent 57,58 locks the rotatable body 20 in the inactive position and prevents inadvertent rotation of the rotatable body 20 to a potentially dangerous active position in which live terminals or contacts 62 might be exposed.

In FIG. 12a, the pivot detent lock 57,58 is shown biased in the direction P to the unengaged position prior to engagement of the pins 86a,b of plug 80 in the crimps 42a,b. With reference to FIG. 12b, one of the plug pins 86a or 86b is shown entering the pin aperture 24a,b. As the active and/or neutral pins 86a,b enter the respective pin apertures 24a,b by moving in direction X, the pivot detent locks 57,58 are deflected and rotated in direction Y by the leading pin edge 89 through to an unlocked position as shown in FIG. 12c. The detents 57,58, rotated against the bias of the spring 59, rotate in direction Y as the pins 86 push downwards in direction X until the rotation limiting stop wall surface 53 of the locks 57,58 meet the facing wall 29 of the rotatable body 20. The plug pin 86a,b is inserted fully into the aperture 24a,b and then the crimp 42a,b so that the lock 57,58 is pushed to a near-vertical position against its spring bias 59.

As the plug 80 is rotated in direction R, the rotatable body 20 turns above the locks 57,58 so that they cannot return to their original positions shown in FIG. 12a until the pin apertures 24a,b return to the inactive position shown in FIG. 12e. Instead, as shown in FIG. 12d, the edge 51 abuts the facing surface 29 as the rotatable body 20 passes over the lock 57,58 in either direction R towards the active position or in direction Z towards the inactive position. The contact that the edge 51 makes in this position causes minimal friction as the rotating body slides passed the lock 57,58. In the active position, the lock remains in a transitional position set at an angle relative to the rotatable body 20 as shown in FIG. 12d.

In FIG. 12d the plug pin 86a,b is shown in the active position. The plug pins 86a,b are held securely in the active or neutral end crimp portion 44a,b as previously described with reference to the active or neutral end crimp portion ramp 46a,b. If the plug 80 is withdrawn from the socket casing 10 in direction W, the rotatable body 20 is free to rotate back in the direction Z, urged by the return spring 36 towards the lock 57, 58, whilst the fixed body 40 remains stationary.

As shown in FIG. 12e, the rotatable body 20 rotates in direction D until complementary stops (not shown) on the rotatable body 20 and fixed body 40 engage thereby defining the limit of rotation of the rotatable body 20 relative to the fixed body 40 in direction D. At this position, the inactive position, the pin aperture 24a,b is in registration with the elbow 55 and abutting edge 51 and the lock 57, 58 flicks back to its horizontal orientation by pivoting about its pivot point associated with the spring 59 in the direction P as in FIG. 12a to lock the rotatable body 20 into its fixed position relative to the fixed body 40. Accordingly, the rotatable body 20 cannot be rotated to the active position from the inactive position without first inserting a plug pin 86a, b to deflect the lock 57, 58 and permit rotation of the rotatable body 20 in cooperation with the plug 80.

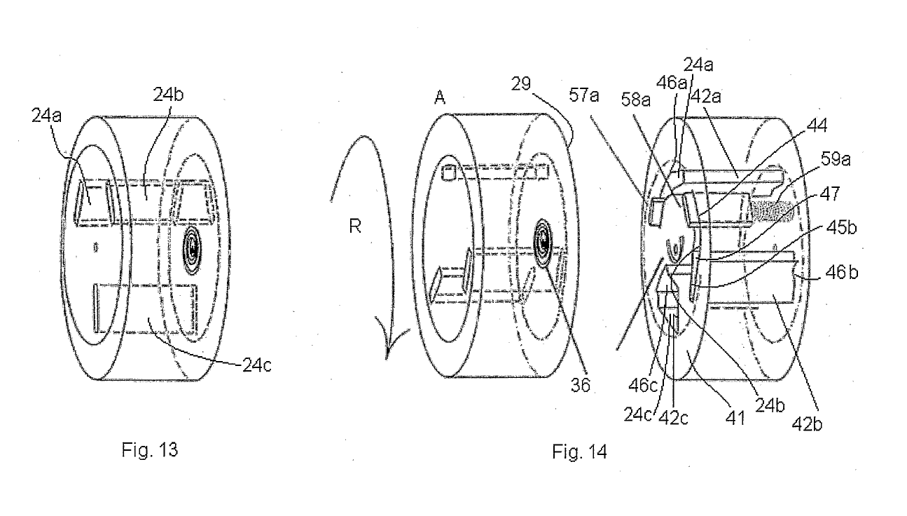

Turning now to the fifth embodiment shown in FIGS. 13 and 14, pin guides 42 in the form of active, neutral and earth crimps 42a-42c are again shown in ghosted lines. The pin guides or crimps 42 are housed in a fixed body 40 behind and coaxially aligned with a rotatable body 20 in a manner analogous to the second embodiment shown in FIGS. 8a-b.

The fixed body 40 also includes a crimp-containing insert 43 in the form of a disc inside an outer fixed donut shaped cylinder 49 corresponding to the insert aperture body 22 and outer hollow cylinder disc 21. The crimps 42 define carefully contoured guides of specific design to control the movement of the pins 86 through the extent of travel from the inactive position as exemplified in FIG. 13 through to the active position shown in FIG. 14.

The rotation of the pins 86 mounted on a plug (not shown) and the rotatable body 20 represents a clockwise rotation to move the active pin 86a to a top most position (A). The guiding crimps 42 apply marginal lateral force to the pins 86 as they are guided through the cavities defined by the crimps 42 until the pins 86 meet a respective ramp 46.

The crimp guides 42 each have respective ramps 46a-46c in the form of shoulder wall formations that cause inward or outward radial displacement of the pins 86 as they are rotated into the active position. Preferably, at least one pin is urged radially outwardly and at least pin is urged radially inwardly to maximise the locking nature in the active position with respect to the engagement of the pins 86 with the end crimp portions 45. However, this is not necessarily the case and the pins 86 may all be urged outwardly or all inwardly as the plug is rotated. The crimp guides 42 generally include three separate zones. For example, with respect to crimp 42b, there is a pin entry zone 44, a transition zone 47 in which the pin 86b travels from the active position at the pin entry zone 44 on its way to the end crimp portion 45. The arrow R indicates the clockwise direction of rotation of the pins 86 from the inactive to the active position. In the Australian 10 A 3-pin standard example, the active and neutral crimps 42a,b are similar in shape and separated by about 60 degrees relative one to the other. The active and neutral crimps 42a,42b include ramp portions 46a, 46b. The respective leading edges of the pins 86a, 86b must ride over the ramps 46a, 46b against the axial bias of the respective pins to their respective longitudinal axes to enter the respective end crimp portions 45.

Other crimp shapes will be advantageously employed for different shaped and oriented plug pins. However, in each case, the crimps 42 will include a corresponding ramp 46 over which the plug pin 86 must ride to enter the end crimp portion 45.

As shown in FIG. 14, instead of or in addition to an arrangement in which the pins 86 or the crimps 42 are radially flexed, the fifth embodiment exemplifies another arrangement in which the plug pins are locked out of the inactive position by the operation of spring-loaded locking pins 57a,58a. At rest the spring-loaded locking pins 57a,58a are axially biased to sit proud above the surface of the crimp housing 40 and to extend partially into the rotatable plug housing 20 by the action of compression springs 59a. When the plug pins 86 are inserted into the apertures 24a-b, they abut the top ends of the spring-loaded locking pins 57a,58a and depress them down and into the pin entry zones 44. As the plug and pins 86 are rotated in direction R, the pins 86 ride off the spring-loaded locking pins 57a,58a which spring back up and into the apertures 24a-b, thereby occupying the part or all of the pin entry zones 44 so that the pins cannot return to the pin entry zones 44 by reverse anticlockwise rotation. The pins 86 may thereby be trapped in the active position until the plug is removed from the socket.

The spring-loaded locking pins 57a,58a may be in a number of different configurations to facilitate locking of the pins 86 in the active position whilst allowing the pins 86 initial entry into the pin entry zones 44. For example, the pins 57a,58a may be cylindrical in shape. The pins 57a,58a may have inclined or ramped top surfaces that facilitate the pins 86 sliding off the top surfaces and into the transition zone 47.

As best seen in FIG. 14, the inner surface 41 of the fixed housing 40 facing the rotatable body internal facing wall 29 is simply a circular wall or disc with the crimp aperture shapes cut out of its surface. The crimps 42 themselves are fixed in the body 40 in the end of the transition zone 47 and the whole of the end portion 45 and provide the electrical contact for the pins 86. The crimps 42 are fundamentally flat-folded U-shaped panels that comprise flanged or flared ends configured to receive the pins 86 on entry to the end portions 45. The shape of the crimps 42 closely follow the corresponding shapes of the crimp apertures 24a-c.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the LED indicators 44 uppermost.

It will be appreciated by those skilled in the art that many modifications and variations may be made to the methods of the invention described herein without departing from the spirit and scope of the invention.

Table of Reference numerals used in drawings:

| Ref | Description |
|---|---|
| 10 | socket casing or housing |
| 12a | front fascia of panel |
| 12b | rear side of panel |
| 14 | LED indicators |
| 14a | first LED indicator |
| 14b | second LED indicator |
| 16 | cylindrical cavity |
| 17 | snap fit engagement means |
| 18 | fasteners |
| 19 | |
| 20 | rotatable disc housing or body |
| 20a | first rotatable housing or body |
| 20b | second rotatable housing or body |
| 21a | first outer solid disc |
| 21b | second outer solid disc |
| 22 | insert aperture body |
| 23 | inner cylindrical cavity |
| 24 | pin apertures |
| 24a | active aperture |
| 24b | neutral aperture |
| 24c | earth aperture |
| 26a | rotational axis |
| 26b | longitudinal axis |
| 28 | fixed housing mount |
| 29 | rotatable body internal facing wall |
| 30 | rotatable housing outer fascia |
| 36 | return spring |
| 40 | fixed housing or body |
| 41 | inner surface of fixed housing |
| 42 | crimps |
| 42a | active crimp |
| 42b | neutral crimp |
| 42c | earth crimp |
| 43 | crimp containing disc |
| 44 | end crimp portions |
| 44a | active end crimp portion |
| 44b | neutral end crimp portion |
| 44c | earth end crimp portion |
| R | Rotation of rotatable disc housing from |
| | inactive to active position |
| 46 | ramps |
| 46a | active end crimp portion ramp |
| 46b | neutral end crimp portion ramp |
| 46c | earth end crimp portion ramp |
| 45a-c | pin entry zones |
| 47a-c | transition zones |
| 48 | spring catch |
| 49 | outer fixed cylinder |
| 50 | detent pin lock |
| 51 | pin abutting surface |
| 52 | lock head |
| 53 | rotation limiting surface |
| 54 | deflectable arm |
| 55 | rotation limiting elbow |
| 56 | pivot anchor |
| 57 | active detent pin lock |
| 57a, 58a | spring-loaded locking pins |
| 58 | neutral detent pin lock |
| 59 | detent spring |
| 59a | compression springs |
| 60 | rear terminal housing |
| 62 | contacts |
| 62a | active contact |
| 62b | neutral contact |
| 62c | earth contact |
| 80 | plug |
| 82 | plug casing |
| 84 | plug cord |
| 86 | pins |
| 86a | active pin |
| 86b | neutral pin |
| 86c | earth pin |
| 87 | finger grip features |
| 88a | active wire |
| 88b | neutral wire |
| 88c | earth wire |
| 89 | detent engaging and leading edge |

| Type | Plug standard | Power rating |
|---|---|---|
| A | NEMA 1-15 unpolarised | 15 A/125 V |
| | NEMA 1-15 polarised | 15 A/125 V |
| | JIS C 8303, Class II | 15 A/100 V |
| B | NEMA 5-15 | 15 A/125 V |
| | NEMA 5 20 | 20 A/125 V |
| | JIS C 8303, Class I | 15 A/100 V |
| C | CEE 7/16 (Europlug) | 2.5 A/250 V |
| | CEE 7/17 | 16 A/250 V |
| | Soviet plug | 6 A/250 V |
| D | BS 546 (2 pin) | 2 A/250 V |
| | | 5 A/250 V - BS 4573 |
| | BS 546 (3 pin) | 2 A/250 V; 5 A/250 V; |
| | | 15 A/250 V = SABS 164 |
| | | 30 A/250 V |
| E | CEE 7/5 | 16 A/250 V |
| F | CEE 7/4 (Schuko) | 16 A/250 V |
| E\|F | CEE 7/7 | 16 A/250 V |
| G | BS 1363, IS 401 & 411, | 13 A/230-240 V |
| | MS 589, SS 145 | |
| H | SI 32 | 16 A/250 V |
| I | AS/NZS 3112 | 10 A/240 V; 20 A/240 V; |
| | | 25 A/240 V; 32 A/240 V |
| | CPCS-CCC | 10 A/250 V |
| | IRAM 2073 | 10 A/250 V |
| J | SEV 1011 | 10 A/250 V; 16 A/250 V |
| K | Section 107-2-DI | 13 A/250 V |
| | Thailand TIS 166 - 2549 | 13 A/250 V |
| L | CEI 23-16/VII | 10 A/250 V; 16 A/250 V |
| M | BS 546 (South African | 15 A/250 V; Type M is |
| | 15 A/250 V); | sometimes used to describe |
| | | the 15 A version of the old |
| | | British type D, used in |
| | | South Africa and elsewhere. |
| — | IEC 60906-1 (2 pin) | 10 A and 20 A/250 V |
| | IEC 60906-1 (3 pin) | 10 A and 20 A/250 V |

1. An electric power socket for receiving an electric plug having a plurality of axially parallel pins, said electric power socket including:
a rear portion housing a set of electrical connections for making electrical contact with the corresponding plug pins;
a fixed portion including a set of guides for reception of said corresponding plug pins;
an axially fixed rotatable body retained in a circular cavity, biased to an electrically inactive position and rotatable through an extent of travel from an inactive position to an active position, said rotatable body including a front panel through which extends a corresponding set of apertures to receive said plug pins, said rotatable body including a front panel; and
a detent for cooperating with at least a first one of said plug pins in said active position and to resist rotation of said rotatable body toward said inactive position,
wherein:
each said aperture remains in registration with a corresponding one of the guides through said extent of travel;
as the plug pins are rotated through the extent of travel, a radial wall of at least one of the guides applies a lateral force to bear against at least one of the plug pins to distort the plug pin out of its axial alignment that it has at rest in the inactive position; and
said rotatable body returns under bias to said inactive position if said plug pins are withdrawn from said power socket.

2. A power socket according to claim 1, wherein the electric plug casing operates as a handle or knob which may be manipulated in the manner of a switch to rotate said rotatable body by said electric plug to connect said plug pins to electric power.

3. A power socket according to claim 1, wherein said guides are in the form of contoured slots along which the respective said plug pins move through said extent of travel.

4. A power socket according to claim 1, wherein as said plug pins are rotated through said extent of travel, the lateral force applied by the at least one guide against the at least one plug pin forces the plug pin into a frictionally locked position in the active position.

5. A power socket according to claim 1, wherein said plurality of plug pins includes an active pin and a neutral pin.

6. A power socket according to claim 1, wherein said plurality of plug pins includes an active pin, a neutral pin and an earth pin,

7. A power socket according to claim 6, wherein at least one of said plug pins is in the shape of a blade having a plane aligned radially relative to the rotatable body's axis.

8. A power socket according to claim 1, wherein said detent is secured to the fixed portion and comprises a resiliently deflectable arm.

9. A power socket according to claim 1, wherein, in the active position, said detent bears against the first plug pin whereby to frictionally trap said first plug pin against a wall of the corresponding guide.

10. A power socket according to claim 1, wherein said guides are crimps and said fixed portion is a crimp housing.

11. A power socket according to claim 1, wherein said fixed portion and said rotatable body are each shaped as a cylindrical disc.

12. A power socket according to claim 11, wherein said rotatable body is aligned coaxially with said fixed portion and has substantially the same diameter.

13. A power socket according to claim 1, wherein said bias is obtained by a spiral spring that lies in a plane coplanar with the facing internal surfaces of said rotatable body and said fixed portion and said spring is centrally mounted on said rotatable body or said fixed portion.

14. A power socket according to claim 14, wherein said spring is mounted on said rotatable body and said fixed portion includes a spring catch against which said spring bears.

15. A method for activating an electric power socket for receiving an electric plug having a plurality of axially parallel pins, the method including the following steps:
housing a set of electrical connections for making electrical contact with the corresponding plug pins in a rear portion of a casing of the electric power socket;
including a set of guides for reception of the corresponding plug pins in a fixed portion in the casing;
retaining an axially fixed rotatable body in a circular cavity in the casing;
biasing the rotatable body to an electrically inactive position, the rotatable body including a front panel through which extends a corresponding set of apertures to receive the plug pins;
inserting the electric plug into the rotatable body so that the plug pins extend through to the fixed portion; and
rotating the electric plug and therefore the rotatable body through an extent of travel from the inactive position to an active position until at least a first one of the plug pins cooperates with a detent in the active position that resists rotation of the rotatable body toward the inactive position,
wherein:
each the aperture remains in registration with a corresponding one of the guides through the extent of travel;
as the plug pins are rotated through the extent of travel, a radial wall of at least one of the guides applies a lateral force to bear against at least one of the plug pins to distort the plug pin out of its axial alignment that it has at rest in the inactive position; and
the rotatable body returns under bias to the inactive position if the plug pins are withdrawn from the power socket.
